(19) United States
(12) Patent Application Publication
(10) Pub. No.: US 2017/0202393 A1
(43) Pub. Date: Jul. 20, 2017

(54) METAL CONTAINER FOR MICROWAVE OVEN

(71) Applicant: ENVASES UNIVERSALES DE MÉXICO, S.A. P.I. DE C.V., Col. Centro Cuautitlan Cuautitlan (MX)

(72) Inventor: Alberto ALVAREZ-ZAVALA, Ciudad Satélite, Naucalpan (MX)

(21) Appl. No.: 15/326,853

(22) PCT Filed: Jul. 15, 2014
(86) PCT No.: PCT/IB2014/063128

§ 371 Date: Jan. 17, 2017

(51) Int. Cl. A47J 36/02; A47J 36/06; B65D 21/02; B65D 81/34

(52) U.S. Cl. CPC A47J 36/027; B65D 81/3453; A47J 36/06; B65D 21/0233

(57) ABSTRACT

The present invention relates to a metal container for microwave oven of the present invention which comprises an integrally molded body which in turn comprises: a base enabling the container to rest on a surface; and a wall divided into at least one wall section extending from the perimeter of the base in order to hold products, with a maximum height of 40 percent of the wavelength of the radiation emitted by the microwave oven; wherein all the angles formed by the inner part of the container at the intersection of planes between the sections are greater than 90° (π/2 radians) and said intersections have a chamfer shape with an arcuate section having a radius of at least 0.5 mm, the ends of the arc being at the points at which the planes which intersect in order to form the angles are tangential to the arc.

### FIELD OF THE INVENTION

The present invention is related to metal containers for containing food products, and more particularly it is related to a metal container that can be heated in a microwave oven and which is easy to store.

### BACKGROUND OF THE INVENTION

There are different types of containers that can be placed in a microwave oven to heat the contents thereof without causing damage to the oven due to its specific characteristics as regards materials used, and in some cases the design of the container.

The materials with which the various containers are constructed include glass, metal, plastic, etc. Metal containers are rigid containers that are resistant to impacts and fire, and constitute a hermetic barrier between the food and the environment, preventing decomposition of the food due to the action of microorganisms or oxidation reactions.

As regards glass containers, said material is inert, impermeable and hermetic, which gives long life to the food contained therein. Due to its physical/chemical structure, this type of container does not deteriorate prematurely, and it is 100% recyclable.

However, in order to preserve some types of foodstuffs, the characteristics of the glass must be modified by tinting it or covering it with some material to prevent light from entering, which can cause damage in the microwave oven during heating, or damage the contents of the container due to the fact that the properties of the covering material or the tinting affect the contents while being heated.

Containers made of plastic have different physical properties, depending on the type of plastic used. The plastics used can be flexible and resistant to corrosion; however, in some cases they are susceptible to premature aging and damage due to the temperature. Moreover, they do not preserve the foodstuffs for much time.

One of the desirable characteristics of metal containers is the rapid heating of its contents when placed in a microwave oven; however, the problem of metal containers is that when placed in the microwave oven, they reflect the waves emitted by the magnetron, which decreases the capacity to heat the foodstuffs and can cause damage to said magnetron.

In the prior art we can find different models of containers constructed of metal materials, which can be placed in a microwave oven. One example is American Patent U.S. Pat. No. 4,558,198, which describes a metal container for foodstuffs, which can be used in conventional or microwave ovens. Said container is characterized in that it is composed of a metal tray and a cover, which are round or oval shaped with rounded corners and smooth walls, wherein the tray has an internal plastic cover of vinyl materials and an external plastic cover of epoxy materials. The cover is constructed of an electrically insulating material, preferably plastic, resistant to heat and transparent to microwaves, which is positioned in the upper part of the tray, insulating the edges of said tray to prevent electric arcs. The tray and the cover are designed to be used multiple times.

One disadvantage that the previously described container has is that it requires two separate elements (a metal tray and a plastic cover) to be able to securely heat the food housed within it by microwaves. In said container, the upper end of the metal tray has an edge that must be covered by the plastic cover to prevent sparks being generated inside the microwave oven. As a result, the plastic material around the metal is what prevents the waves from being reflected, damaging the magnetron, which depends on the user, since if the cover is not put in place, there is a risk of damaging the oven.

Another example of the prior art is the American Patent U.S. Pat. No. 4,689,458 which describes a metal container especially designed for cooking doughy or pasta-type foods in a microwave oven, as well as an improved cover. Said container has a curved perimeter wall and an orifice in the bottom thereof, wherein a plastic insert that is transparent to microwaves is placed, which is used to seal the base of the container. The objective is that a selective exposure to the microwaves radiation is generated in the lower and interior portions of the container. The container includes a dome-shaped cover that has removable dampeners or shields of metal sheet to allow a controlled exposure of the adjacent surfaces of the food. The container and the cover are disposable.

The container described above is constructed of metal elements and plastic parts; it has the disadvantage that the plastic insert placed in the bottom of the container is secured thereto by means of adhesives, which can allow accumulation of dirt and residues between the two elements, damaging the contents; moreover, said insert can become detached, reducing the useful life of the container. Furthermore, this container is designed for the sole purpose of cooking pastas and doughs, so it is not suitable for transporting and preserving canned foods.

American Patent U.S. Pat. No. 7,112,771 B2 describes a container for foods or beverages which can be used to store foods as well as for cooking them in a conventional or microwave oven. Said container is composed of metal parts and parts that are transparent to microwaves, which together manage to heat the contents from the inside. Said container can be used not only to cook, but also as a food storage element for which it has a removable seal, which when removed, allows the food to be heated in a microwave oven. The shape of said container can be cylindrical or conical, contributing to its ease of transport and storage. The container can include a plastic cover which covers it and in turn insulates the edges with a plastic skirt or wall to prevent electric arcs. Said cover has a plurality of perforations to allow steam to escape.

One of the disadvantages of the above-mentioned container is that it is constructed of various materials and is conformed by at least three elements which must be attached so that said container can be placed in and operable in a microwave oven. Said container has a removable seal for the storage of foodstuffs. For these same reasons, said container is not suitable for transporting canned foods therein.

To resolve the disadvantages of the prior art, a completely metal container has been developed which, due to its specific dimensions succeeds in heating its contents in a microwave oven without reflecting the microwaves, thus preventing damage to the oven; moreover, due to said characteristic dimensions, it is easily stored. Furthermore, the container is suitable for preserving and transporting foodstuffs to the point of sale in the container.

### OBJECTS OF THE INVENTION

Considering the defects of the prior art, an object of the present invention is to provide a container that can be used in the marketing of canned foods, i.e., for the preservation of foods that can be transported to the point of sale in the metal container, and which do not require changing container for heating in a microwave oven.

Another object of the present invention is to provide a completely metal container for heating the contents thereof in a microwave oven without damaging the oven due to rebounding electromagnetic waves.

Another object of the present invention is to provide a metal container which, when empty and without a cover, is stackable making it more efficient in terms of space occupied by said container during its transportation and storage.

Another object of the present invention is to develop a metal container that comprises a coating that gives it the ability to have a trademark or drawing placed on the outer surface of the container, longer useful life and that can be heated in a microwave oven without damaging the oven.

An additional object of the present invention is to provide a metal container that is economical to produce but which is highly resistant to physical and chemical deterioration.

### BRIEF DESCRIPTION OF THE INVENTION

The present invention relates to a metal container for containing food products which, due to its design characteristics, specific dimensions and even the coating material, succeeds in heating its contents in a microwave oven without causing damage to the oven. Moreover, thanks to the particular dimensions of the container, it manages to be easily stored in a stackable manner and is useful for preserving foods therein and, therefore, for marketing canned foods that do not need to be removed from the container for heating in a microwave oven.

The metal container for microwave oven of the present invention comprises an integrally molded body which in turn comprises:

a base enabling the container to rest on a surface; and

a wall divided into at least one wall section extending from the perimeter of the base in order to hold products, with a maximum height of 40% of the wavelength of the radiation emitted by the microwave oven; wherein all the angles formed by the inner part of the container at the intersection of planes between the sections are equal to or greater than 90° (π/2 radians) and such intersections have the form of chamfers with an arcuate section having a radius of at least 0.5 mm, wherein the ends of the arc are at the points at which the planes which intersect in order to form the angles are tangential to the arc.

The novel aspects of the invention, as well as the operation and advantages thereof will be better understood from the figures and the detailed description of the invention.

### BRIEF DESCRIPTION OF THE FIGURES

FIG. 1 is an isometric view of one embodiment of the metal container of the present invention.

FIG. 2 is a cross-sectional view of the metal container of FIG. 1.

FIG. 3 is an enlarged cross-sectional view of one side of the base of the metal container of FIG. 1.

FIG. 4 is an enlarged cross-sectional view of one side of the edge of the metal container of FIG. 1.

FIG. 5 shows a preferred embodiment of the metal container of FIG. 1 with a capacity of 98 ml.

FIG. 6 shows another preferred embodiment of the metal container of FIG. 1 with a capacity of 156 ml.

### DETAILED DESCRIPTION OF THE INVENTION

The present invention refers to a metal container that enables its contents to be heated in a microwave oven. The specific design of said container prevents the electromagnetic waves generated by the magnetron in the microwave oven from rebounding, thus preventing damage to the oven when heating the contents of the container.

In order for the waves produced by the magnetron of the oven not to rebound or be reflected, the metal container must not contain section joints in right or sharp angles, measured in the internal faces. One of the main characteristics for the container to be placed in the microwave oven is that all of the internal angles of the structure must be equal to or greater than 90° (π/2 radians), measured by the internal faces of the body of the container, since angles of less than 90° cause the electromagnetic waves to be reflected, thus damaging the oven.

The metal container for microwave oven of the present invention comprises an integrally molded body which in turn comprises: a base enabling the container to rest on a surface; and a wall divided into at least one wall section extending from the perimeter of the base in order to hold products, with a maximum height of 40% of the wavelength of the radiation emitted by the microwave oven; wherein all the angles formed by the inner part of the container at the intersection of planes are equal to or greater than 90° (π/2 radians) and said intersections have the shape of chamfers with an arcuate section having a radius of at least 0.5 mm, the ends of the arc being at the points at which the planes which intersect in order to form the angles are tangential to the arc.

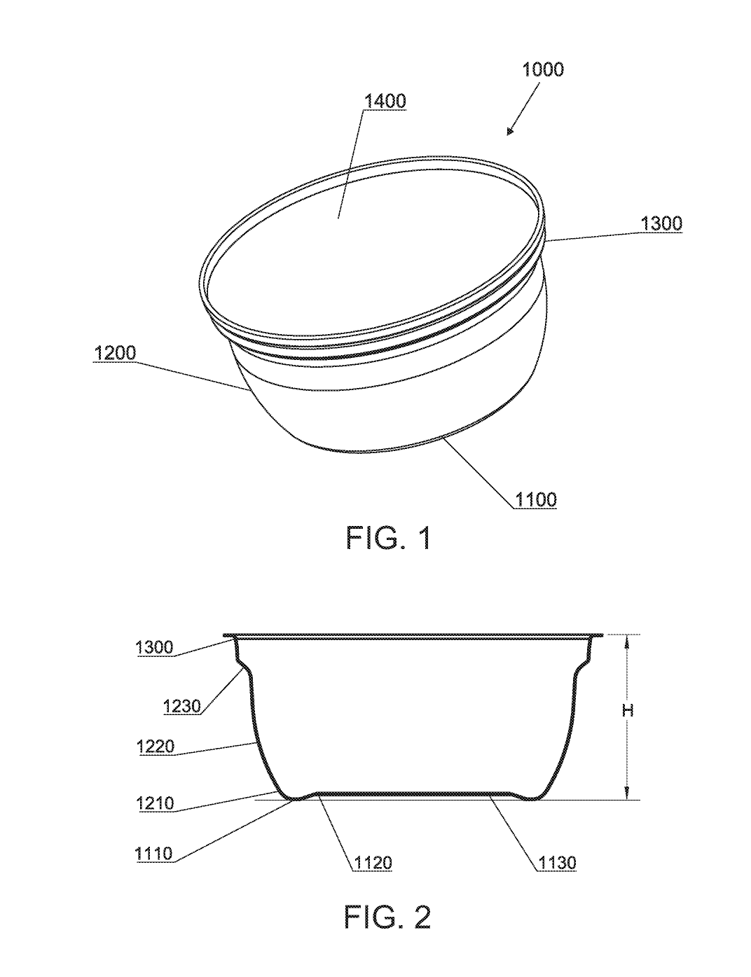

To better comprehend the principles of the present invention, it will be described with respect to an embodiment illustrated in FIG. 1.

FIG. 1 shows a design of the prior art, with the principles defined in the present invention, i.e., it has dimensions with respect to specific angles, radii and lengths to achieve the object of the invention.

The metal container (1000) for microwave oven of the present invention comprises an integrally molded body which in turn comprises: a base (1100) enabling the container to rest on a surface; and a wall (1200) divided into at least one wall section which extends from the perimeter of the base to contain products, with a maximum height (H) of 40% of the wavelength of the radiation emitted by the microwave oven.

All the angles formed by the inner part of the container are equal to or greater than 90° (π/2 radians) and the wall sections (1200) are formed by a chamfer with an arcuate section having a radius of at least 0.5 mm, wherein the ends of the arc are at the points at which the planes of the sections which intersect are tangential to the arc.

The metal container (1000) also comprises an edge (1300) in the upper part, which has a shape defined to receive a cover (1400).

To prevent the waves from rebounding or reflecting inside the oven causing damage, the height (H) must be of no more than 40% of the wavelength of the radiation emitted by the microwave oven, which is approximately 12 cm in a typical oven.

As a means to illustrate the best way to implement the invention, in the following the specific characteristics of two containers with the same industrial design but different capacities, one of 98 ml and the other of 156 ml are described.

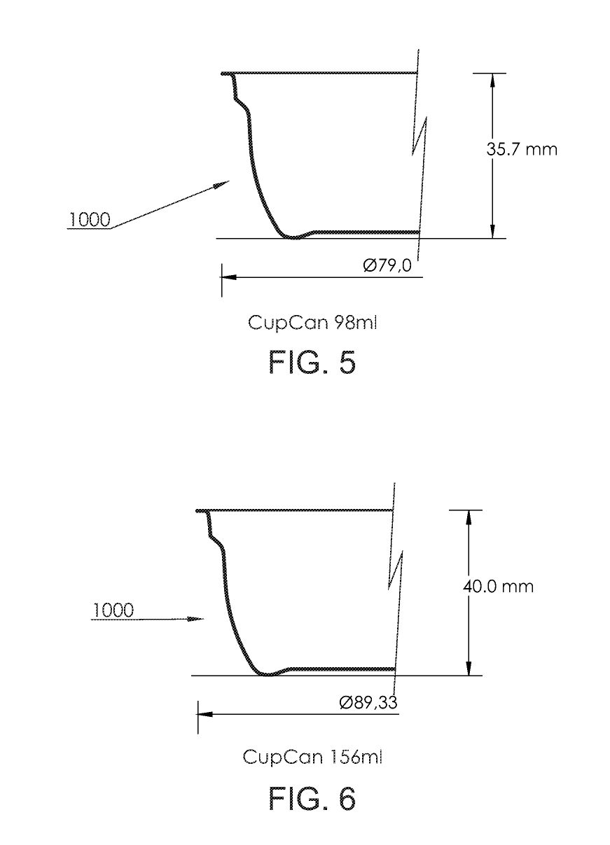

In the 98 ml container embodiment (FIG. 5), the total height of the container (H) is approximately 35.7 mm, while the same height is of approximately 40 mm for the 156 ml container (FIG. 6).

The industrial design specifically used to illustrate both capacity embodiments is shown in FIG. 2, where the metal container has three sections (1110, 1120, 1130) at the base (1100) that are joined to the wall (1200) by at least one of its sections, which in turn are attached to the edge (1300) of the container.

The three base sections (1100) are formed by a support section (1110), a transition section (1120) and a bottom section (1130).

The wall (1200) of the metal container which is shown in FIG. 2 has at least three wall sections (1210, 1220, 1230), where the first wall section (1210) is connected to the support section (1110) of the base, the second wall section (1220) connects the first wall section (1210) to the third wall section (1230), which in turn is connected to the edge (1300) of the metal container.

The junctions between the different sections that make up the design of the metal container illustrated in the figures, form angles (α) that are equal to or greater than 90° and form a chamfer with an arcuate section having a radius (r) of at least 0.5 mm, the ends of the arcuate section being at the points at which the planes which intersect in order to form the angles, are tangential to the arc.

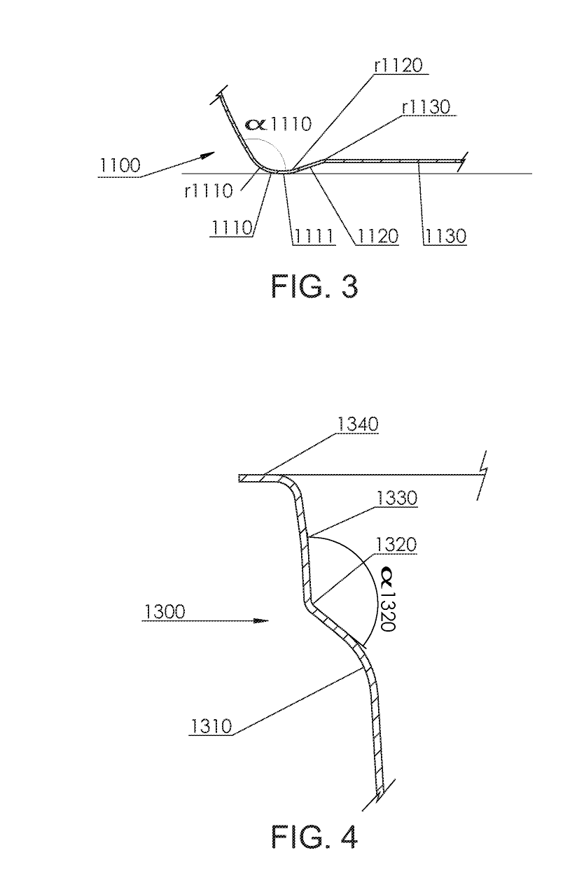

FIG. 3 shows an enlarged view of one side of the base (1100) of the same design as illustrated in FIG. 2, which shows the support section (1110), the transition section (1120) and the bottom section (1130).

The support section (1110) is formed by a horizontal line (1111), parallel to the surface, said horizontal line (1111) measures approximately 1 mm and helps to support the container on any type of surface. The support section (1110) is joined to the first wall section (1210) by a chamfer that has an arcuate section having a radius of 4 mm (r₁₁₁₀) and which is tangent to the horizontal line (1111).

The transition section (1120) is a sloped line that starts from the horizontal line (1111) up to a height of approximately 1.2 mm and a length of approximately 6 mm, a chamfer is formed at the junction between the horizontal line (1111) and the sloped line of the transition section and (1120) which has an arcuate section with a radius of 3 mm (r₁₁₂₀).

The bottom section (1130) is a circular plane that is joined to the transition section (1120) by an intersection with a chamfer of an arcuate section having a radius of 3 mm (r₁₁₃₀).

The circular plane (1130) in the 98 ml container embodiment has a diameter of approximately 32 mm, while in the 156 ml container embodiment the diameter is of approximately 45.7 mm.

The wall of the metal container (1200) has at least three sections (1210, 1220, 1230) which join the base (1100) to the edge of the container (1300).

The first wall section (1210) is comprised of part of the arcuate section of the chamfer with a radius of 4 mm (r₁₁₁₀) which is joined to the second wall section (1220) and forms an angle α (α₁₁₁₀).

The second wall section (1220) is a chamfer with an arcuate section whose radius (r₁₂₂₀) will depend on the capacity of the container. One end of the arcuate section of the chamfer (1220) is tangential to the first wall section (1210) and another end of the arcuate section of the chamfer (1220) is tangential to the third wall section (1230).

The second wall section (1220) represents the largest curve of the container and is defined in this way in order to generate a larger surface of contact with the waves generated by the oven in a curved area where the waves do not rebound or are reflected; moreover, it provides a desired capacity of contents in the metal container and avoids having container heights of more than 40% of the wavelength of the radiation emitted by the microwaves.

The second wall section (1220) has a radius (r₁₂₂₀) of approximately 42.8 mm for the 98 ml container and approximately 44 mm for the 156 ml container.

The third wall section (1230) is a line tangential to the second wall section (1220) which connects with the edge (1300) and which forms an angle α (α₁₃₀₀). The angle α is preferably 3° measured from a vertical line (1330) in the edge of the container (1300). Said dimensions of the third wall section (1230) enable it to be stacked for easier transportation and storage when the container is empty. To define the dimension of the third wall section (1230), a height can be defined starting from a horizontal plane where the second wall section (1220) and the third wall section (1230) are joined up to another horizontal plane where the third wall section (1230) and the upper part of the edge of the container (1300) are joined. Said height between the horizontal planes will be of approximately 4.6 mm for the 98 ml container, while the height for the 156 ml container is of approximately 6.9 mm.

FIG. 4 shows an enlarged view of one side of the edge (1300) of the metal container (1000) which is designed so that its dimensions are used for any capacity of the container.

The third wall section (1230) is joined to a sloped line of the edge (1320) with a chamfer in an arcuate section that has a radius of approximately 2 mm in the 98 ml container and 4 mm in the 156 ml container (r₁₃₁₀) and which forms an angle of 130° (α₁₃₂₀) with respect to a vertical line of the edge (1330). The sloped line of the edge (1320) joins the vertical line (1330), the vertex forming a chamfer of arcuate section having a radius of 0.5 mm (r₁₃₂₀) between said vertical line (1330) and the sloped line (1320).

The vertical line (1330) joins a horizontal line (1340) forming a rim at the upper part. Said horizontal line (1340) is approximately 3 mm long and the junction between the vertical line (1330) and the horizontal line (1340) form a chamfer with arcuate section having a radius of 1.2 mm (r₁₃₃₀).

Finally, with respect to the diameters measured in a general way in the container, the edge (1300) has a diameter of approximately 73 mm for the 98 ml container and 83.3 mm for the 156 ml container.

FIGS. 5 and 6 show alternative embodiments of the invention where FIG. 5 shows a portion of the metal container with capacity of 98 ml while FIG. 6 shows a portion of the metal container with capacity of 156 ml.

As it has been mentioned throughout the description, said specific geometric characteristics provide advantages to the present invention over the prior art since, all of the internal angles of the body of the container being equal to or greater than 90° and (π/2 radians), they do not allow the electromagnetic waves generated by the magnetron of the oven to rebound or be reflected, thus preventing damage thereto.

In another embodiment of the invention, to better preserve the food during storage and transport, the container includes a cover (1400), preferably of the type that can be placed in a microwave oven, and more preferably selected from the easy-opening type, membrane type, among others known in the prior art that are compatible with metal surfaces. In the embodiment in which the cover cannot be placed in a microwave oven, the cover must be removed prior to placing the container in said oven. Nevertheless, in the preferred embodiment in which the cover can be placed in a microwave oven, the container can be stored with the food inside it and unopened, and safely be placed in the microwave oven.

The present invention will be even better understood from the following examples, which are provided solely for illustrative purposes to enable a thorough comprehension of the present invention; this does not imply that there are not other embodiments, not illustrated, that can be practiced based on the detailed description performed above.

### EXAMPLES

Some examples are presented in the following, which show the performance of the metal container when placed in a microwave oven.

### Example 1

### Variation of Chamfer Arcs Radii Between Planes in a 98 ml Container

A 98 ml metal container was manufactured by the deep drawing process in two phases, formation of cup and cutting of flange according to the principles of the industrial design D654,6635, illustrated in FIG. 5, but with different radii of the chamfers between planes of the container.

To that end, containers were manufactured in accordance with the specifications of Table 1, varying the radius (r₁₃₂₀) of the chamfer between the sloped line (1320) and the vertical line (1330) of the edge of the container (1300), which has an angle (α₁₃₂₀) of 130°; said chamfer represents the arc that requires the smaller radius according to the design selected for the example.

TABLE 1
Tests of containers with a 98 ml capacity (FIG. 5)

| | R1 | R2 | R3 | R4 | R5 | R6 | R7 | R8 |
|---|---|---|---|---|---|---|---|---|
| Radius | 0.9 mm | 0.8 mm | 0.7 mm | 0.6 mm | 0.5 mm | 0.4 mm | 0.3 mm | 0.2 mm |
| r₁₃₂₀ | | | | | | | | |
| Angle | 130 | 130 | 130 | 130 | 130 | 130 | 130 | 130 |
| α₁₃₂₀ | | | | | | | | |

In addition, angle α₁₁₁₀ is kept at a value of 90°, which according to the principles of the present invention should be sufficient for heating in the microwave oven.

For each specification of Table 1, 8 containers were manufactured, each of which was placed in a 1000 W microwave oven with a microwave wavelength of 12 cm for 180 seconds. The behavior of the container in the oven was recorded at 30-second intervals to verify the moment at which a spark could occur inside the oven. The results are shown in Table 2 for each radius variation, where, in cases in which there was a spark, the average time that each container lasted can be observed.

TABLE 2
Test of minimum radius in the Microwave
Oven with angle α₁₃₂₀ = 130

| | 30-60 | 60-90 | 90-120 | 120-150 | 150-180 |
|---|---|---|---|---|---|
| | sec. | sec. | sec. | sec. | sec. |
| R1 (r₁₃₂₀ = 0.9 mm) | Ok | Ok | Ok | Ok | Ok |
| R2 (r₁₃₂₀ = 0.8 mm) | Ok | Ok | Ok | Ok | Ok |
| R3 (r₁₃₂₀ = 0.7 mm) | Ok | Ok | Ok | Ok | Ok |
| R4 (r₁₃₂₀ = 0.6 mm) | Ok | Ok | Ok | Ok | Ok |
| R5 (r₁₃₂₀ = 0.5 mm) | Ok | Ok | Ok | Ok | Ok |
| R6 (r₁₃₂₀ = 0.4 mm) | Ok | Ok | Ok | Ok | **Variable |
| R7 (r₁₃₂₀ = 0.3 mm) | *6.1 sec. | N/A | N/A | N/A | N/A |
| R8 (r₁₃₂₀ = 0.2 mm) | *4.4 sec. | N/A | N/A | N/A | N/A |

*Note:
The result is the average time the container took to cause a spark in the microwave oven with respect to 8 containers.
**With an r₁₃₂₀ of 0.4 mm, two of the test containers (R6) could cause a small spark.

### Example 2

### Variation of Chamfer Arcs Radii Between Planes in a 156 ml Container

A 156 ml metal container was manufactured by a deep drawing process in two phases, formation of cup and cutting of flange according to the principles of the industrial design D654,663S, illustrated in FIG. 6, but with different radii of the chamfers between planes of the container.

To that end, containers were manufactured in accordance with the specifications of Table 3, varying the radius (r₁₃₂₀) of the chamfer between the sloped line (1320) and the vertical line (1330) of the edge of the container (1300), which has an angle (α₁₃₂₀) of 130°; said chamfer represents the arc that requires the smaller radius according to the design selected for the example.

TABLE 3
Tests of containers with a 156 ml capacity (FIG. 6)

| | R1 | R2 | R3 | R4 | R5 | R6 | R7 | R8 |
|---|---|---|---|---|---|---|---|---|
| Radius | 0.9 mm | 0.8 mm | 0.7 mm | 0.6 mm | 0.5 mm | 0.4 mm | 0.3 mm | 0.2 mm |
| r₁₃₂₀ | | | | | | | | |
| Angle | 130 | 130 | 130 | 130 | 130 | 130 | 130 | 130 |
| α₁₃₂₀ | | | | | | | | |

In addition, angle α₁₁₁₀ is kept at a value of 90°, which according to the principles of the present invention should be sufficient for heating in the microwave oven.

For each specification of Table 3, 8 containers were manufactured, each of which was placed in a 1000 W microwave oven with a microwave wavelength of 12 cm, for 180 seconds. The behavior of the container in the oven was recorded at 30 second intervals to verify the moment at which a spark could occur inside the oven. The results are shown in Table 4 for each variation of radius, where, in cases in which there was a spark, the average time that each container lasted can be observed.

TABLE 4
Test of minimum radius in the Microwave
Oven with angle α₁₃₂₀ = 130

| | 30-60 | 60-90 | 90-120 | 120-150 | 150-180 |
|---|---|---|---|---|---|
| | sec. | sec. | sec. | sec. | sec. |
| R1 (r₁₃₂₀ = 0.9 mm) | Ok | Ok | Ok | Ok | Ok |
| R2 (r₁₃₂₀ = 0.8 mm) | Ok | Ok | Ok | Ok | Ok |
| R3 (r₁₃₂₀ = 0.7 mm) | Ok | Ok | Ok | Ok | Ok |
| R4 (r₁₃₂₀ = 0.6 mm) | Ok | Ok | Ok | Ok | Ok |
| R5 (r₁₃₂₀ = 0.5 mm) | Ok | Ok | Ok | Ok | Ok |
| R6 (r₁₃₂₀ = 0.4 mm) | Ok | Ok | Ok | Ok | **Variable |
| R7 (r₁₃₂₀ = 0.3 mm) | *6.1 sec. | N/A | N/A | N/A | N/A |
| R8 (r₁₃₂₀ = 0.2 mm) | *4.4 sec. | N/A | N/A | N/A | N/A |

*Note:
The result is the average time the container took to cause a spark in the microwave oven with respect to 8 containers.
**With an r₁₃₂₀ of 0.4 mm, two of the test containers (R6) could cause a small spark.

### Example 3

### Angles Variation Between Planes in a 98 ml Container

A 98 ml metal container was manufactured by a deep drawing process in two phases, formation of cup and cutting of flange according to the principles of the industrial design D654,663S, illustrated in the figures, but with different angles (α₁₁₁₀) between the support section of the base (1100) and the first wall section (1210).

To that end, containers were manufactured according to the specifications of Table 5, varying the angle (α₁₁₁₀) between the support section of the base (1100) and the first wall section (1210) where the radius (r₁₁₁₀) is of 4 mm and represents the smallest angle required according to the design selected for the example (verify information).

TABLE 5
Tests of containers with a 156 ml capacity (FIG. 5)

| | R9 | R10 | R11 | R12 | R13 | R14 | R15 | R16 |
|---|---|---|---|---|---|---|---|---|
| Angle | 94 | 93 | 92 | 91 | 90 | 89 | 88 | 87 |
| α₁₁₁₀ | | | | | | | | |
| Radius | 4 mm | 4 mm | 4 mm | 4 mm | 4 mm | 4 mm | 4 mm | 4 mm |
| r₁₁₁₀ | | | | | | | | |

Moreover, the smallest possible radius according to the tested design was kept at r₁₃₂₀=0.5 mm to prevent said radius from affecting the test related to the angle.

For each specification of Table 5, 8 containers were manufactured, each of which was placed in a 1000 W microwave oven with a microwave wavelength of 12 cm, for 180 seconds. The behavior of the container in the oven was recorded at 30 second intervals to verify the moment at which a spark could occur inside the oven. The results are shown in Table 6 for each angle variation, where the average time that each container lasted can be observed, in cases in which there was a spark.

TABLE 6
Test of Angles in the Microwave Oven with radius = 4 mm

| | 30-60 | 60-90 | 90-120 | 120-150 | 150-180 |
|---|---|---|---|---|---|
| | sec. | sec. | sec. | sec. | sec. |
| R9 (α₁₃₂₀ = 94°) | Ok | Ok | Ok | Ok | Ok |
| R10 (α₁₃₂₀ = 93°) | Ok | Ok | Ok | Ok | Ok |
| R11 (α₁₃₂₀ = 92°) | Ok | Ok | Ok | Ok | Ok |
| R12 (α₁₃₂₀ = 91°) | Ok | Ok | Ok | Ok | Ok |
| R13 (α₁₃₂₀ = 90°) | Ok | Ok | Ok | Ok | Ok |
| R14 (α₁₃₂₀ = 89°) | *9.8 sec. | N/A | N/A | N/A | N/A |
| R15 (α₁₃₂₀ = 88°) | *6.5 sec. | N/A | N/A | N/A | N/A |
| R16 (α₁₃₂₀ = 87°) | *6.2 sec. | N/A | N/A | N/A | N/A |

*Note:
The result is the average time the container took to cause a spark in the microwave oven with respect to 8 containers.

### Example 4

### Variation of Angles Between Planes in a 156 ml Container

A 156 ml metal container was manufactured by a deep drawing process in two phases, formation of cup and cutting of flange according to the principles of the industrial design D654,663S, illustrated in the figures, but with different angles between the support section of the base (1100) and the first wall section (1210).

To that end, containers were manufactured according to the specifications of Table 7, varying the angle (α₁₁₁₀) between the support section of the base (1100) and the first wall section (1210) where the radius (r₁₁₁₀) is 4 mm and represents the smallest angle required according to the design selected for the example (verify information).

TABLE 7
Tests of containers with a 156 ml capacity (FIG. 5)

| | R9 | R10 | R11 | R12 | R13 | R14 | R15 | R16 |
|---|---|---|---|---|---|---|---|---|
| Angle | 94 | 93 | 92 | 91 | 90 | 89 | 88 | 87 |
| α₁₁₁₀ | | | | | | | | |
| Radius | 4 mm | 4 mm | 4 mm | 4 mm | 4 mm | 4 mm | 4 mm | 4 mm |
| r₁₁₁₀ | | | | | | | | |

Moreover, the smallest possible radius according to the tested design was kept at r₁₃₂₀=0.5 mm to prevent said radius from affecting the test related to the angle.

For each specification of Table 7, 8 containers were manufactured, each of which was placed in a 1000 W microwave oven with a microwave wavelength of 12 cm, for 180 seconds. The behavior of the container in the oven was recorded at 30 second intervals to verify the moment at which a spark could occur inside the oven. The results are shown in Table 8 for each angle variation, where the average time that each container lasted can be observed, in cases in which there was a spark.

TABLE 8
Test of Angles in the Microwave Oven with radius = 4 mm

| | 30-60 | 60-90 | 90-120 | 120-150 | 150-180 |
|---|---|---|---|---|---|
| | sec. | sec. | sec. | sec. | sec. |
| R9 (α₁₃₂₀ = 94°) | Ok | Ok | Ok | Ok | Ok |
| R10 (α₁₃₂₀ = 93°) | Ok | Ok | Ok | Ok | Ok |
| R11 (α₁₃₂₀ = 92°) | Ok | Ok | Ok | Ok | Ok |
| R12 (α₁₃₂₀ = 91°) | Ok | Ok | Ok | Ok | Ok |
| R13 (α₁₃₂₀ = 90°) | Ok | Ok | Ok | Ok | Ok |
| R14 (α₁₃₂₀ = 89°) | *9.8 sec. | N/A | N/A | N/A | N/A |
| R15 (α₁₃₂₀ = 88°) | *6.5 sec. | N/A | N/A | N/A | N/A |
| R16 (α₁₃₂₀ = 87°) | *6.2 sec. | N/A | N/A | N/A | N/A |

*Note:
The result is the average time the container took to cause a spark in the microwave oven with respect to 8 containers.

There are no examples of the embodiment but with a cover (it was applied to 8 containers) according to the description and the same tests were performed, obtaining satisfactory results.

### Example 5

### Tests of 98 and 156 ml Metal Containers with a Cover

In accordance with the results obtained in the previous examples, containers R3, R4, R11 and R12 were selected and functioned appropriately when heated in the microwave oven, and they were again submitted to tests but this time including the cover to evaluate performance. The results of the tests of the container with a cover are shown in Table 9.

TABLE 9
Test of container with a cover

| | 30-60 | 60-90 | 90-120 | 120-150 | 150-180 |
|---|---|---|---|---|---|
| | sec. | sec. | sec. | sec. | sec. |
| R3 | Ok | Ok | Ok | Ok | Ok |
| R4 | Ok | Ok | Ok | Ok | Ok |
| R11 | Ok | Ok | Ok | Ok | Ok |
| R12 | Ok | Ok | Ok | Ok | Ok |

Observing the foregoing, it was corroborated that when using a cover of the type that can include easy open, membrane, among others, the container can also be heated in the oven without causing damage thereto.

As can be concluded, when containers were evaluated with a radius (R₁₃₂₀) of less than 0.5 mm, the oven caused sparks during the first 10 seconds; likewise, when the angle formed between the support section of the base and first wall section was less than 90°, sparks were caused during the first 10 seconds.

Notwithstanding the foregoing, when the container had a radius (R₁₃₂₀) of 0.4 mm, there were containers that caused sparks within the range of 150 to 180 seconds.

It has therefore been shown that even with the same design of container that can be found in the prior art, by strictly following the principles of the design of the present application, the metal container can be placed in the oven without causing damage thereto, while those manufactured based solely on the design but without following the dimensions specifically, will cause damage to the oven and will not be able to heat the contents.

Consequently, the present invention shall not be considered as restricted except as required by the prior art and by the scope of the appended claims.

1. A metal container for microwave oven that comprises an integrally molded body which in turn comprises: a base enabling the container to rest on a surface; and a wall divided into at least one wall section extending from the perimeter of the base in order to hold products, with a maximum height of 40 percent of the wavelength of the radiation emitted by the microwave oven; wherein all the angles formed by the inner part of the container at the intersection of planes between the sections are equal to or greater than 90° and said intersections have a chamfer shape with an arcuate section having a radius of at least 0.5 mm, wherein the ends of the arc being at the points at which the planes which intersect in order to form the angles are tangential to the arc.

2. The container according to claim 1, wherein it comprises an edge at the upper part that has a shape defined to receive a cover.

3. The container according to claim 1, wherein the maximum height is 12 cm.

4. The container according to claim 3, wherein it has a capacity of between 98 ml and 156 ml.

5. The container according to claim 4, wherein the total height is between 35 mm and 40 mm depending on the capacity.

6. The container according to claim 1, wherein the base comprises three sections formed by a support section, a transition section and a bottom section that are joined to the wall by at least one of its sections.

7. The container according to claim 2, wherein the wall has at least three wall sections where the first wall section is joined to the support section of the base, the second wall section joins the first wall section with the third wall section, which in turn is joined to the edge of the metal container.

8. The container according to claim 2, wherein the edge has a diameter from 73 mm to 84 mm depending on the capacity.

9. The container according to claim 2, wherein the container comprises a cover, preferably of the type that can be placed in a microwave oven.

10. The container according to claim 9, wherein the cover is selected from the easy-opening type, membrane type or any other type compatible with metal surfaces.
